(19) United States
(12) Patent Application Publication
(10) Pub. No.: US 2012/0002442 A1
(43) Pub. Date: Jan. 5, 2012

(54) DISPLAY DEVICE FOR A VEHICLE AND METHOD FOR PRODUCING THE DISPLAY DEVICE

(75) Inventors: Peter Brandt, Aschaffenburg (DE); Heiko Charle, Ruesselsheim (DE); Wilfried Schulz, Eppstein (DE)

(73) Assignee: GM GLOBAL TECHNOLOGY OPERATIONS LLC, Detroit, MI (US)

(21) Appl. No.: 13/255,628

(22) PCT Filed: Mar. 9, 2010
(86) PCT No.: PCT/EP2010/001447

§ 371 Date: Sep. 9, 2011

(30) Foreign Application Priority Data
Mar. 10, 2009 (DE) 10 2009 011 948.5

(51) Int. Cl. F21S 8/10; B23P 11/00; F21V 7/00

(52) U.S. Cl. 362/609; 362/613; 29/428

(57) ABSTRACT

A display apparatus is provided for a vehicle and a method for manufacturing the display apparatus. The display apparatus includes, but is not limited to a display screen and a background lighting. Illuminated characters are disposed, imaged, or activated on the display screen. The background lighting of the display screen includes, but is not limited to illuminants which emit light into a light guide body. The light guide body is disposed on a rear side of the display screen. The light guide body includes, but is not limited to a light guide plate made of an optically transparent plastic compound, in which optically non-transparent partitions for light guide zones of the light guide body, which are optically shielded from one another, are introduced.

### CROSS-REFERENCE TO RELATED APPLICATIONS

This application is a U.S. National-Stage entry under 35 U.S.C. §371 based on International Application No. PCT/EP2010/001447, filed Mar. 9, 2010, which was published under PCT Article 21(2) and which claims priority to German Application No. 10 2009 011 948.5, filed Mar. 10, 2009, which are all hereby incorporated in their entirety by reference.

### TECHNICAL FIELD

The technical field relates to a display apparatus for a vehicle and a method for manufacturing the display apparatus. The display apparatus comprises a display screen and a background lighting. Illuminated characters are disposed, imaged, or activated on the display screen. The background lighting of the display screen comprises illuminants, which emit light into a light guide body. The light guide body is disposed on a rear side of the display screen. At the same time, the light guide body comprises a light guide plate made of an optically transparent plastic compound.

### BACKGROUND

A monochrome display apparatus comprising a display screen and a backlight provided for a backlighting of the display screen is known from the document DE 10 2005 045 692 A1. The backlight comprises a light source having a first color and a light source having a second color. To this end, a first light conductor is coupled to the first light source and a second light conductor is coupled to the second light source. The two light conductors are disposed closely adjacent to one another, behind the display screen of the display apparatus in such a manner that they backlight the entire display extensively and an area of the display associated with the first light conductor with a first color and an area of the display associated with the second light conductor with the second color.

Such a display apparatus has the disadvantage that for a plurality of different-colored illuminated areas, a plurality of individual light conductors is required, which are to be connected to light sources having the corresponding colors or color filters. This arrangement of a plurality of light conductors is cost-intensive and results in a complex structure of closed adjacently disposed light conductors, which can then be illuminated with a respectively different color. The separation of the individual lighting areas or the individual light conductors requires a minimum width to prevent overlighting of the respectively other color. At the same time, these separations must project as close as possible onto the underside of the display screen in order to partition off the individual areas in a lightproof manner. It is disadvantageous here that the separations are possibly visible on the display screen.

FIG. 9A, FIG. 9B and FIG. 9C show such a display apparatus 6 known from the prior art. FIG. 9A shows a schematic view of a display screen 8 having structured transparent openings 41 to 47, where the structured transparent openings 41 to 45 are the positions of a gear shift lever in automatic mode as backlit characters 11 to 15. In automatic shifting mode, these characters disposed in the transparent openings 41 to 45 light up green, for example, whereas the characters 16 and 17, which are characterized with the backlit character 16 for a manual shift of the gears into the next higher gear or by the backlit character 17 for a manual shift into the next lower gear, light up red. However, if the shift lever is not operated in automatic mode but in the manual shift mode, the characters 16 and 17 in the display screen 8 light up green whilst the automatic characters 11 to 15 emit red.

FIG. 9B shows schematically a partial area of a light guide plate 21 of a backlight 9, where the positions of the characters 14 to 17 are indicated by dashed lines. In order to explain the different coloring and also the switching of the colors, FIG. 9C shows a schematic section through the display apparatus 6 according to the prior art. The light guide plate 21 is delimited laterally by metal-coated lateral regions 51 and 52 and is covered by the display screen 8, which has structured openings 45 and 46 filled with a transparent plastic compound 22, through which light can emerge. The light guide plate 21 is made of a transparent plastic compound 22, which can be illuminated in different colors from the rear side 32 by appropriate illuminants 18.

These illuminants 18 are disposed in chambers of an illuminating box or light box 49 and irradiate the light guide plate 21 from the rear side 32, where the colors mix partially in the transparent openings 46 and 47 due to multiple reflections inside the light guide plate 21, so that the color assignment as provided for manual and automatic mode is not unique. In order to avoid this mixing of colors, according to the prior art two separate light guide plates would need to be produced and provided with appropriate partitions, which however involves increased costs and complex production steps.

It is at least one object to provide a display apparatus and a method for producing the same, which enables a considerable cost saving with a simultaneously improved display image. In addition, it is at least another object to prevent coupling of light into neighboring light conductor areas and to avoid any color mixing between neighboring light conductors. In addition, other objects, desirable features and characteristics will become apparent from the subsequent summary and detailed description, and the appended claims, taken in conjunction with the accompanying drawings and this background.

### SUMMARY

According to an embodiment of the invention, a display apparatus is provided for a vehicle and a method for manufacturing the display apparatus. The display apparatus comprises a display screen and a background lighting. Illuminated characters are disposed, imaged, or activated on the display screen. The background lighting of the display screen comprises illuminants, which emit light into a light guide body. The light guide body is disposed on a rear side of the display screen. At the same time, the light guide body comprises a light guide plate made of an optically transparent plastic compound, in which optically non-transparent partitions for light guide zones of the light guide body, which are optically shielded from one another, are introduced by means of laser irradiation of the plastic compound. This display apparatus has the advantage that there is no need to position a plurality of light guide bodies or light guide plates adjacent to one another and provide appropriate partitions in between but the display apparatus according to the invention comprises a plurality of adjacently disposed light guide zones in a single light guide plate, which are merely screened optically from one another by dividing surfaces introduced thermally into the light guide body or the light guide plate, where the light guide zones can have different, also curved, contours since, by introducing the partitions into the transparent plastic compound with energy conversion of the plastic compound, a high design freedom is possible with simultaneously low costs for designing the light guide plate. At the same time, the partitions preferably extend through the light guide body from an upper side disposed on the rear side of the display screen as far as a rear side of the light guide body. Consequently, the color mixing shown in FIG. 9 is prevented by these continuous optically screening partitions.

In an embodiment, the edges of the light guide body are largely kept free of partitions and the illuminants emit a bright light over the partition-free edges as background lighting into the edges for homogeneous illumination of the light guide body or the light guide zones. If a light guide zone does not lie on one of the edges of the light guide plate, these zones can be illuminated separately from the rear side of the light guide plate individually with different colors.

Preferably light sources having different colors are disposed on the edges of the light guide plate, where respectively one light guide zone that can be illuminated from one edge is illuminated by one of the light sources. The rear side of the light guide plate can comprise a reflection layer or a reflection film, where this reflection layer and/or the reflection film can also be assigned to a light box, in which the light guide plate is disposed.

The rear side of the light guide plate can have reflection-layer-free areas to light guide zones, where differently colored light can be coupled into the light guide zones via the reflection-layer-free areas. It is thereby possible either to illuminate all the light guide zones of a light guide plate from the rear side and switch between different colors per light guide zone or to largely illuminate the light guide zones from the edge, where illumination from the rear side is only possible in cases in which one or more of the light guide zones does not extend as far as the edge of a light guide plate.

A display screen is located opposite the rear side of the light guide plate, which display screen preferably comprises a structured optically opaque film, where the film has structured transparent openings for the illuminated characters. Instead of a film, a structured optically opaque coating such as a chrome coating can also be applied to the transparent plastic compound, where the optically opaque coating is applied to the upper side of the light guide body in such a manner that structured transparent openings remain for the illuminated characters. In addition, it is possible to apply a correspondingly structured coating to a transparent film as a display screen. Furthermore, it is possible to provide a self-supporting display screen with appropriately introduced and structured transparent openings or to apply an LCD screen (Liquid Crystal Display) as a display screen to the light guide body structured in the light guide zones.

In order to form the partitions, the transparent plastic compound can comprise light-absorbing spots or light-reflecting spots, which contact one another in the vertical direction through the light guide body and/or overlap one another, and thereby form an appropriate optically shielding partition.

In an embodiment, the partitions are composed of burn-in spots, which contact and/or overlap one another in the vertical direction. Such burn-in spots can be introduced by high focused energy input into a corresponding transparent plastic compound, without the light guide plate or the light guide body needing to be separated into individual light guide plates, as in the prior art. In this case, the burn-in spots preferably form agglomerates of carbon precipitates of the transparent plastic compound, which preferably comprises polycarbonate, where the carbon of the polycarbonate chains is isolated by a focused energy input and can be compacted to form carbon agglomerates.

A method for manufacturing a display apparatus of a vehicle comprises the following process steps. Firstly, a plate of a light guide material is manufactured for a plurality of light guide bodies for display apparatuses. Optically shielding partitions are introduced into the transparent light guide material to form light guide zones. The plate of light guide material is then divided into individual light guide bodies which are adapted to the size and shape of a display screen. The display apparatus comprising display screen and background lighting with light guide zones of a light guide body optically shielded from one another by optically shielding partitions which have been introduced, is then installed in a light box with illuminants for different-colored illumination of the light guide zones of the light guide body.

The display screen can be prepared as a self-supporting and shaped as well as structured optically opaque plate apart from transparent openings for the illuminated characters and can be applied to the light guide body when assembling the display apparatus or it can be vapor-deposited and structured on a preformed light guide body of the display screen made of an optically opaque material. Finally, instead of a permanent display screen, it is also possible to provide an LCD screen which is particularly suitable for instrument display devices since the characters to be imaged can be variably activated.

In relatively inexpensive LCD screens, a coarse pixel structure is provided for the DOT matrix. Since the invention provides the possibility of already achieving, instead of this coarse pixel structure of the LCD screens, finely curved, even annular structures in the light guide plate, it is possible to image curved to annular structures on the display screen since these are already provided in the light guide plate. To this end, such a character is formed by two partitions comprising an inner partition and an outer partition surrounding the inner partition as a light guide zone and for example, light is emitted from the rear side into the curved light guide zone, which can contrast in color from the shade of the background lighting.

In an embodiment, the introduction of the optically shielding partitions is executed with a three-dimensional laser scanner in such a manner that light-absorbing spots or light-reflecting spots are formed in a transparent plastic compound, which contact one another and/or overlap one another in the vertical direction through the light guide body.

### BRIEF DESCRIPTION OF THE DRAWINGS

The present invention will hereinafter be described in conjunction with the following drawing figures, wherein like numerals denote like elements, and:

FIG. 1 shows a schematic perspective view of a vehicle with display apparatus according to an embodiment of the invention;

FIG. 2 shows a schematic exploded perspective view of a display apparatus according to a first embodiment of the invention;

FIG. 3 shows a schematic plan view of a transparent light guide body with light emission from the lateral edges for dashboard illuminations according to a second embodiment of the invention;

FIG. 4 shows a schematic diagram for the method of manufacturing light guide zones in a light guide body of a display apparatus according to a third embodiment of the invention;

FIG. 5 shows a schematic plan view of a light guide body with display screen according to the third embodiment of the invention;

FIG. 6 shows a schematic plan view of a light guide body with display screen according to a fourth embodiment of the invention;

FIG. 7 shows a schematic plan view of a light guide body with display screen according to a fifth embodiment of the invention;

FIG. 8 shows schematic views of the display apparatus according to FIG. 7; and

FIG. 9 shows schematic diagrams of a display apparatus according to the prior art.

### DETAILED DESCRIPTION

The following detailed description is merely exemplary in nature and is not intended to limit application and uses. Furthermore, there is no intention to be bound by any theory presented in the preceding background or summary or the following detailed description.

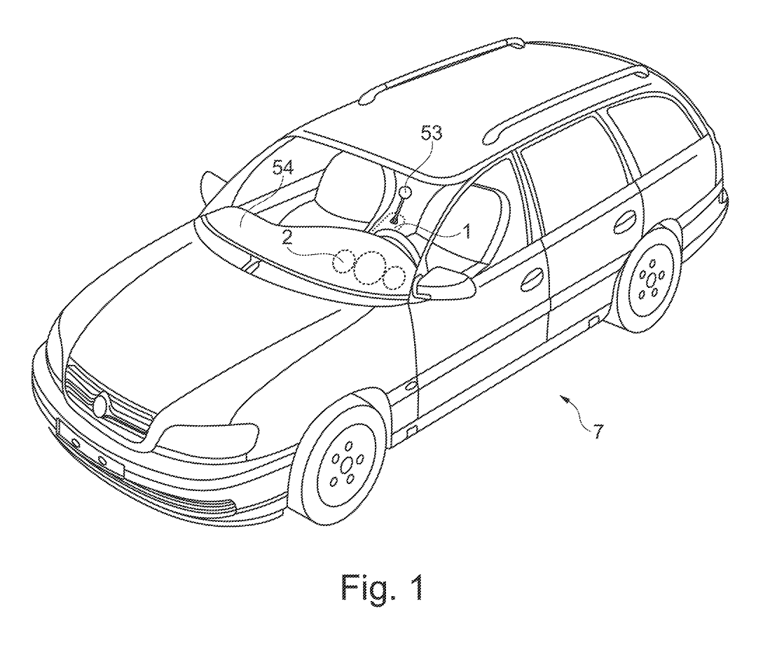

FIG. 1 shows a schematic perspective view of a vehicle 7 having display apparatuses 1 and 2, where the display apparatus 1 comprises illuminated characters with differently lighting-up colors of a gear shift lever 53 and where the display apparatus 2 comprises dashboard instruments and/or symbols of the dashboard 54 of the vehicle 7.

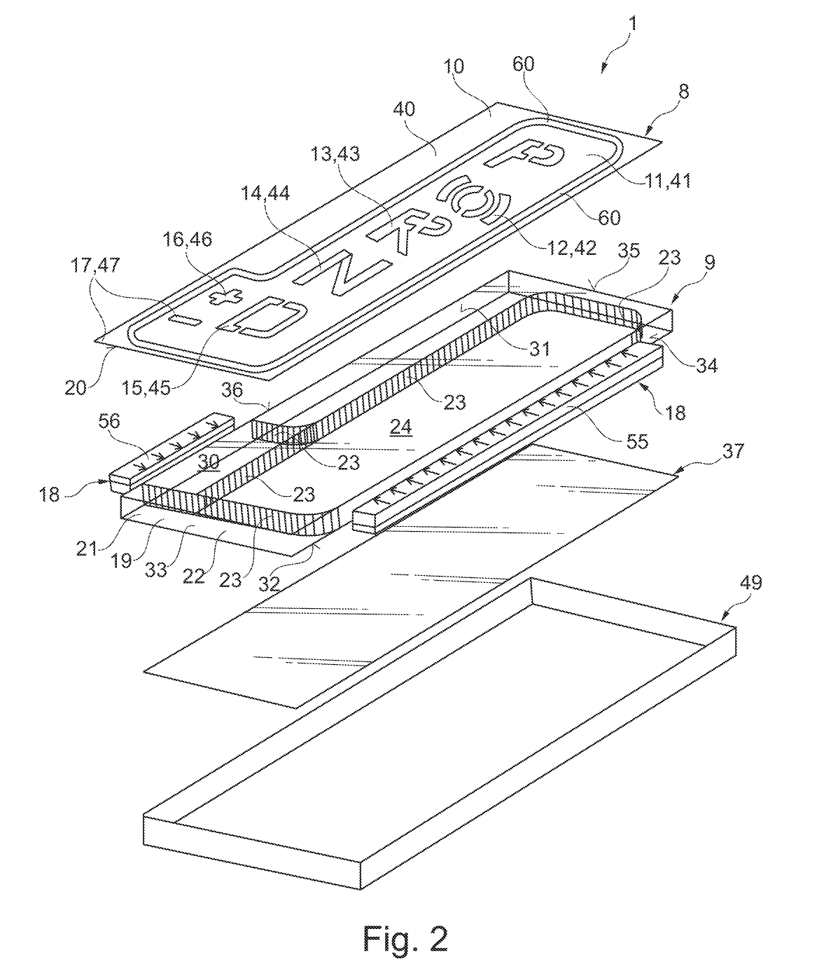

FIG. 2 shows a schematic exploded perspective view of a display apparatus 1 according to a first embodiment of the invention. This display apparatus 1 is composed of four components, a display screen 8, a background lighting 9, a reflection film 37, and a light box 49, which accommodates the reflection film 37 and the light guide body 19 with illuminants 18 and serves as a holder for these components of the display apparatus. Instead of the reflection film 37, the light box can also be fitted with a reflection coating.

The display screen 8 can be configured as a self-supporting translucent component having a structured optically opaque coating 10, where the optically opaque coating 10 has transparent openings 41 to 47 and 60, through which the transparent material is illuminated from the rear side 20 of the display screen 8 with the aid of the background lighting 9 of the light guide body 19. Instead of a self-supporting screen, an optically opaque film having transparent openings 41 to 47 and 60 can also be fixed on an upper side 31 of the light guide body. The structured transparent openings 41 to 47 thereby form indirectly illuminated characters 11 to 17.

The light guide body 19 has a transparent plastic material 22 in the form of a light guide plate 21 with an upper side 31 and a rear side 32. Of the edges 33 to 36, the opposite edges 34 and 36 comprise illuminants 18 which in this embodiment, form two colored light-emitting diode arrays 55 and 56, which are disposed at the edges 34 or 36 of the light guide plate 21 in the areas free from light-shielding partitions 23. In this embodiment, the light-emitting diode arrays 55 and 56 comprise two light-emitting diode arrays disposed one above the other with different colors, for example, green and red, which can selectively be activated.

Light-shielding partitions 23 are introduced into the light guide body 19, which extend from the upper side 31 to the rear side 32 of the light guide body 19 and in this embodiment of the invention, surround a light guide zone 24, which can be illuminated laterally from the edge zone of the lateral edge 34, which is free from such a light-shielding surface. In addition, the light-shielding partitions 23 surround a further light guide zone 30, which can be illuminated by the dichromatic light-emitting diode array 56, for example, either green or red. The light guide zones 24 and 30, which are shielded from one another, are illuminated relatively homogeneously by multiple and total reflection, where the upper side 31 of the light guide body 19 has a light coupling-out structure, which can emit light emitted by the light-emitting arrays of light-emitting diodes onto the marginal sides 34 and 36 orthogonal to the marginal sides in the direction of the display screen.

Instead of a display screen 8 shown here with fixedly predefined backlit characters in an optically opaque coating 10, the display screen can also comprise an LCD matrix by which means, depending on costs, extensive selectable liquid crystal regions having dimensions in the millimeter range or small liquid crystal regions having dimensions in the micrometer range, can be switched between a transmitting and an absorbing state so that it is possible to fit any display of an instrument with the display apparatus.

As a result of the possibility of introducing arbitrarily curved contours of light guide zones 24 and 30 into the background lighting 9 from a light guide body 19 by forming light-shielding partitions 23, it is also possible to incorporate finely structured curved characters, symbols, or company logos in instrument displays having an inexpensive LCD screen with relatively coarse pixel matrix. Then for example, the intermediate space between nested curved partitions can be illuminated from the rear side 32 of a light guide plate 21 with the aid of an additional illuminant, so that even in a coarse pixel matrix of an inexpensive LCD screen, curved and/or annular contours can be imaged with uniform and exact contours in an additional color, for example, as a warning triangle or in the form of a circular company logo.

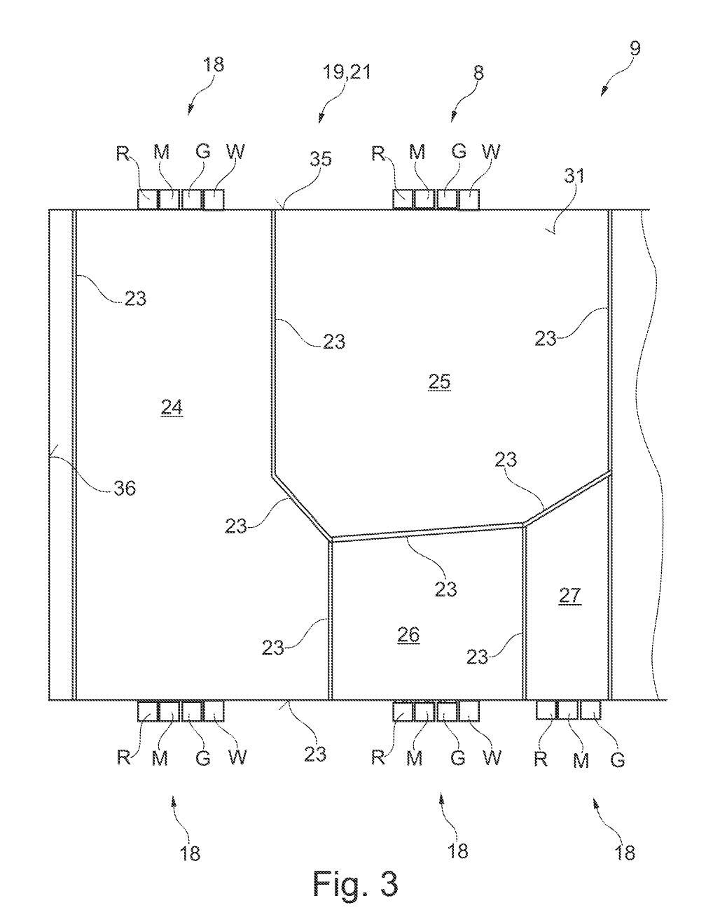

FIG. 3 shows a schematic plan view of a transparent light guide body 19 with light emission from the lateral edges 33 and 35 for dashboard illuminations of display apparatus 2 according to a second embodiment. In this embodiment, merely a partial area of the light guide body 19 is shown, which is divided into seven light guide zones 24 to 27 by introducing light-shielding partitions 23. In this case, each light guide zone 24 to 27 can be illuminated from the marginal sides 33 and 35 by a light-emitting diode array, for example, of red R, magenta M, and green G, as well as white W emitting diodes.

As a result of the multiple and total reflection within this light guide plate 21, the light of the individual light guide zones 24 to 27 can be emitted in different color combinations relatively homogeneously over a coupling-out structure on the upper side 31 of the light guide plate 21, where light-emitting diodes in red R, magenta M, green G, and white W of the light-emitting diode array can be activated differently. For reasons of cost, only two colors such as, for example, red R and green G, can be provided as background lighting.

For example, red R can serve as a warning color and green G as an indicator color. If such a light guide plate having light guide zones 24 to 27, which can be differently shielded from one another and arbitrarily structured, is used as background lighting 9 of a display apparatus 2 of an instrument or a dashboard, for example, in an instrument panel, a more flexible and inexpensive monochromatic LCD screen having a coarse pixel matrix can be used as a display screen in order to make differently colored and variable characters and symbols light up on the instrument.

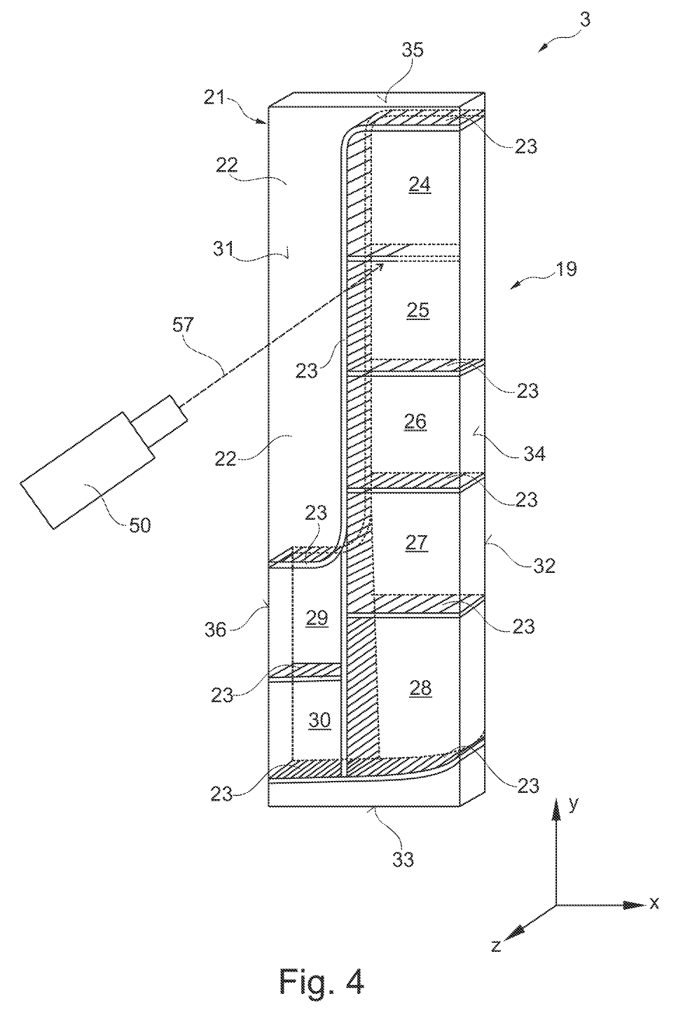

FIG. 4 shows a schematic diagram for the method of manufacturing light guide zones 24 to 30 in a light guide body 19 of a display apparatus 3 according to a third embodiment. The light guide body 19 is formed by a light guide plate 21 having a rectangular shape, which has the marginal sides 33 to 36. Partitions 23 extending from the upper side 31 to the rear side 32 are introduced into the light guide body 19 by means of a three-dimensional laser scanner 50 by varying the focal point of the three-dimensional laser scanner 50. As a result of the thermal action of the three-dimensionally focusable laser beam 57, light-absorbing or light-reflecting spots are formed, which contact one another and/or overlap in the vertical z-direction and form non-shielding walls in the light guide body 19. By keeping the lateral edges 34 and 36 of the light guide plate 21 free from such light-shielding partitions, it is possible to couple light from these marginal sides 34 and 36 and from the rear side 32 into the light guide body 19.

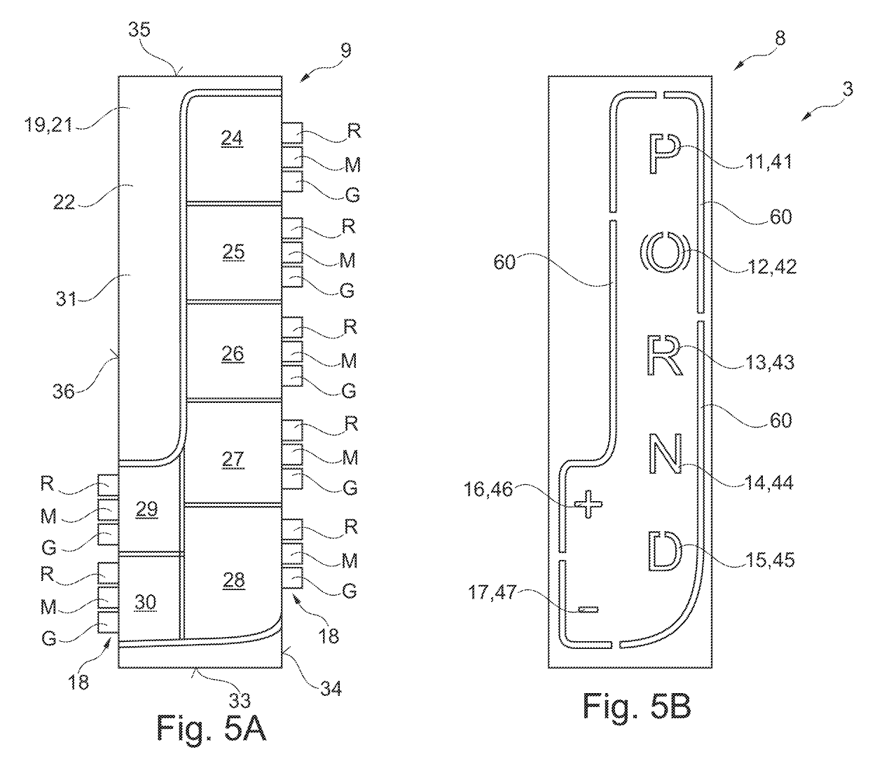

FIG. 5 shows a schematic plan view of a light guide body 19 with display screen 8 according to the third embodiment. FIG. 5A shows the light guide body 19, which as a result of illuminants 18 from the marginal sides 34 and 36 forms a flexible background lighting 9 in the light guide zones 24 to 30. In this case, each light guide zone 24 to 30 is equipped with separate illuminants 18, which for example are equipped from light-emitting diode arrays comprising red R, magenta M, and green G emitting light-emitting diodes. In this embodiment, a display screen 8 as shown in FIG. 5B is backlit onto such a background lighting, which can activate different colors in each of the light guide zones 24 to 30. The illuminated characters 11 to 17 can light up individually illuminable shift positions of a gear shift lever, as shown in FIG. 1. In so doing, it is possible to switch over from an automatic mode having the illuminated characters 11 to 15 into a manual shifting mode having the characters + and −.

With the aid of the background lighting 9 shown in FIG. 5A it is possible to make the respective position of the gear shift lever light up green while the remaining positions of the automatic gear shift light up white and the non-actuated manual shift positions with the characters 16 and 17 of the gear shift lever light up red. If the system is switched to manual shifting, all the characters 11 to 15 provided for the automatic gear shift are switched to red and the two characters for the manual engagement of gears are displayed by green and white in the manual shift mode.

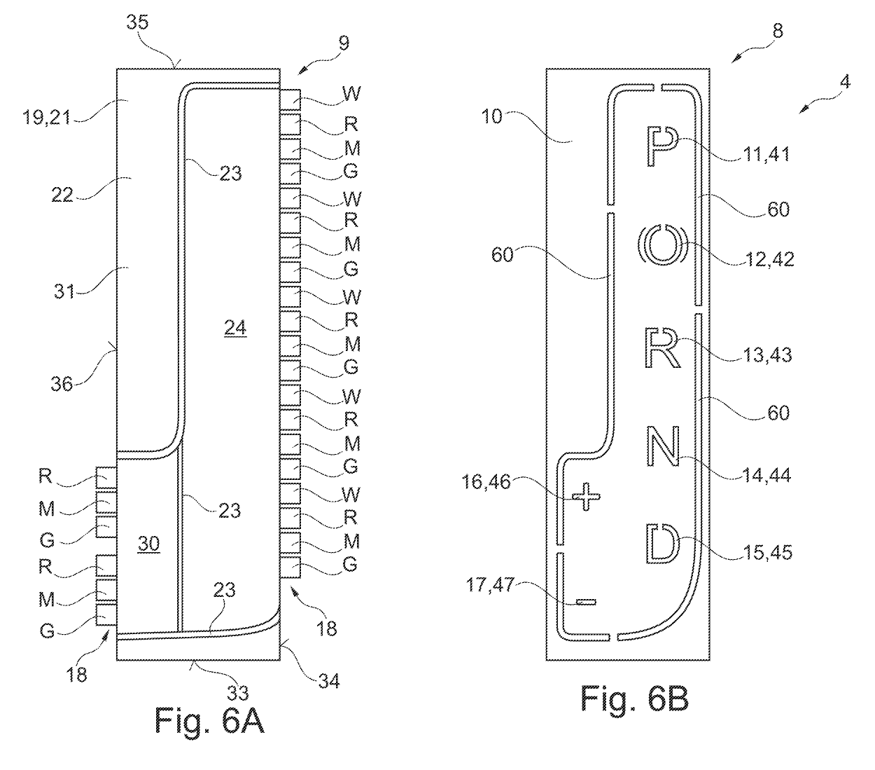

FIG. 6 shows a schematic plan view of a light guide body 19 with display screen 8 according to a fourth embodiment. In this case, FIG. 6A again shows the background lighting 9 in the form of a light guide body 19, which is configured as a light guide plate 21 and has merely two light guide zones 24 and 30, where the light guide zone 24 is provided for the automatic shifting and the light guide zone 30 is provided for the manual shifting possibility. At the same time, a plurality of light-emitting diodes disposed adjacently on the lateral edge 34 or 36 is provided, where these light-emitting diodes, for example, can make the three color components red R, magenta M, and green G light up as well as a brightly illuminating background color W. FIG. 5B in turn shows the appurtenant display screen 8 with the shift positions of the automatic shift comprising illuminated characters 1 to 15, which as a result of the common light guide zone 24, as shown in FIG. 6A, light up in one color while the characters 16 and 17 can light up simultaneously in another color. If, for example, the automatic shift is operating, the automatic shift positions can light up green, for example, with the aid of the light guide zone 24 and the manual shift positions can light up red, for example, with the aid of the light guide zone 30 and conversely.

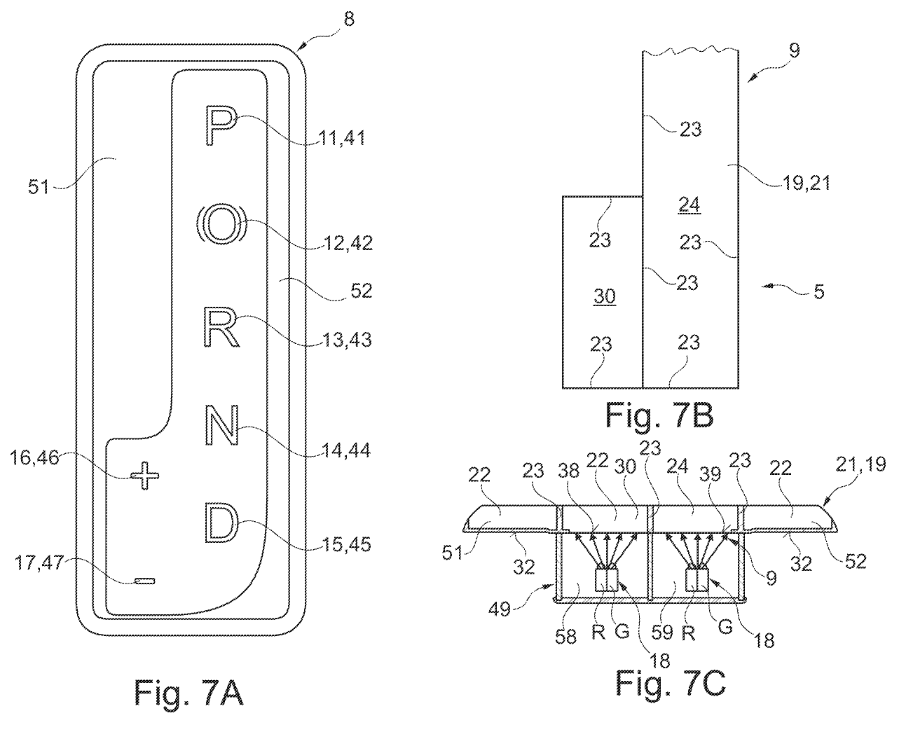

FIG. 7 shows schematic views of a display apparatus 5 according to a fifth embodiment. Components having the same functions as in the preceding figures are identified with the same reference numbers and not discussed additionally. In this embodiment, for example, the display panel of a gear shift lever is shown with differently illuminated characters 11 to 17, with FIG. 7A showing a plan view of the display screen 8 and FIG. 7B showing the background lighting 9, onto which the display screen 8 can be applied. The background lighting 9 comprises two light guide zones 24 and 30 in a light guide plate 21, where both the light guide zone 30 and the light guide zone 24 are completely surrounded by partitions 23 since in this embodiment, as shown in FIG. 7C, the light guide zones 24 and 30 of the light guide plate 21 are illuminated from the rear side 32 of the light guide plate 21.

In addition, as shown in FIG. 7C, a light box 49 having light chambers 58 and 59 is disposed on the rear side 32, each light chamber having an illuminant 18 with two light-emitting diodes red R and green G, which illuminate the light guide body 19 shown in FIG. 7B. The transparent plastic material 22 of the light guide plate 21 is divided into lateral regions 51 and 52 and illuminated light guide zones 24 and 30, where the lateral regions 51 and 52 are shielded from the illuminated regions by light-shielding partitions 23 and the illuminated regions are partitioned off from one another by a shielding partition 23 between the light guide zones 24 and 30 so that no color mixing can occur.

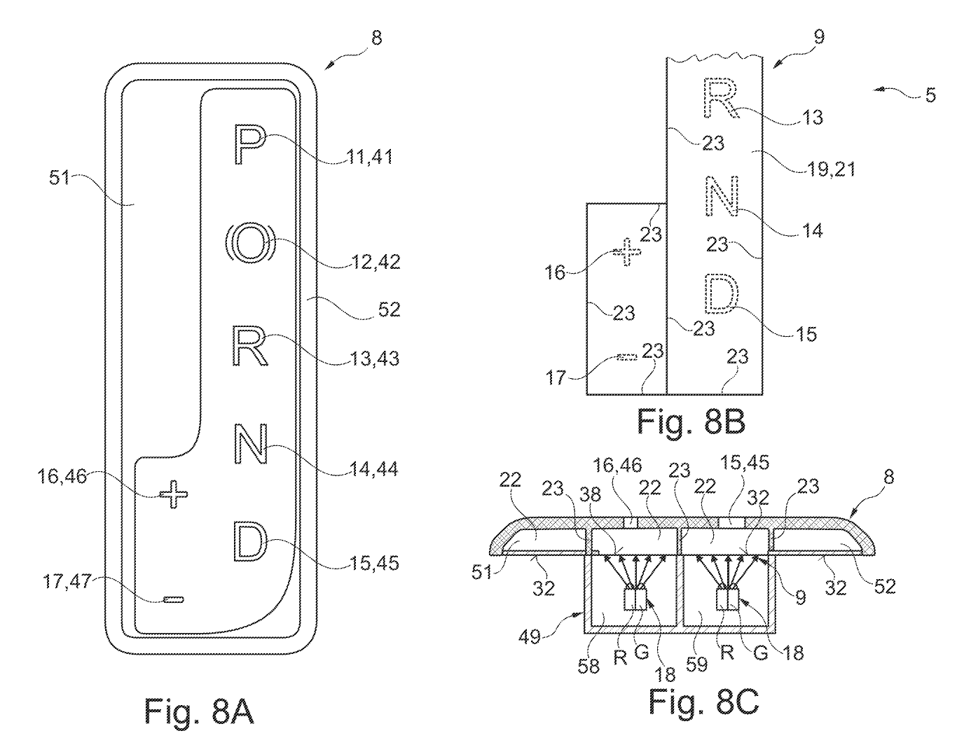

FIG. 8 shows schematic views of the display apparatus 5 according to FIG. 7, where FIG. 8A corresponds to FIG. 7A and FIG. 8B corresponds to FIG. 7B with positions of the characters 13 to 17 which can be backlit indicated by dashed lines. In FIG. 8C the assembly of display screen 8 and background lighting 9 can now be seen in cross-section, where the display screen 8 consists of an optically opaque plastic compound, which is fixed with its rear side 20 on the upper side 31 of the light guide plate 21. Through the transparent openings 45 and 46 in the optically opaque plastic compound of the display screen 8, the light of the light guide zones 24 and 30, which are shielded from one another, is incident on the rear side 20 of the display screen 8 and can be emitted through the openings 15 having a transparent plastic compound. This transparent plastic compound disposed in the openings protects the display screen 8 from accumulations of dust.

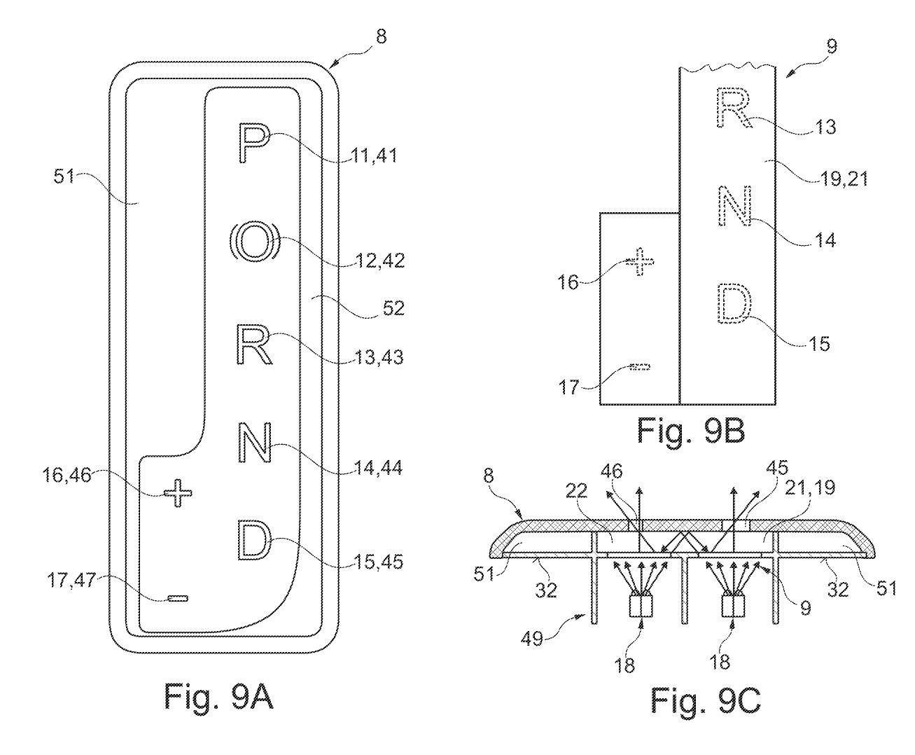

FIG. 9 shows schematic diagrams of a display apparatus according to the prior art, as has already been discussed initially with its disadvantages so that this will not be repeated here.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A display apparatus for a vehicle, comprising:
a display screen configured to display illuminated characters;
a light guide body disposed on a rear side of the display screen, the light guide body comprising a light guide plate made of an optically transparent plastic compound in which optically shielding partitions for light guide zones of the light guide body, which are optically shielded from one another, are introduced with laser irradiation of the plastic compound; and
a background lighting of the display screen, configured to emits light into the light guide body with illuminants.

2. The display apparatus according to claim 1, wherein the optically shielding partitions extend through the light guide body from an upper side of the light guide body disposed toward the rear side of the display screen as far as a rear side of the light guide body.

3. The display apparatus according to claim 1, wherein the optically shielding partitions have differently curved contours of the light guide zones.

4. The display apparatus according to claim 1, wherein the partition-free edges of the light guide body are kept substantially free of partitions and the illuminants emit a bright light over the partition-free edges as background lighting into the partition-free edges for homogeneous illumination.

5. The display apparatus according to claim 4, wherein light sources having different color are disposed on the partition-free edges of the light guide plate and a respectively one of the light guide zones that can be illuminated from one edge is illuminated by one of the light sources.

6. The display apparatus according to claim 2, wherein the rear side of the light guide plate comprises a reflection layer configured to support a total reflection of the light coupled into the light guide zones.

7. The display apparatus according to claim 2, characterized in that
wherein the rear side of the light guide plate has reflection-layer-free areas to the light guide zones, and
wherein differently colored light are coupled into the light guide zones via the reflection-layer-free areas.

8. The display apparatus according to claim 1,
wherein the display screen comprises a structured optically opaque film, and
wherein the film has structured transparent openings for the illuminated characters.

9. The display apparatus according to claim 1,
wherein the display screen is formed by a structured optically opaque layer, and
wherein the layer is applied to the upper side of the light guide body and has structured transparent openings for the illuminated characters.

10. The display apparatus according to claim 1, wherein the display screen comprises an LCD screen.

11. The display apparatus according to claim 1, wherein the transparent plastic compound comprises light spots that contact one another in a vertical direction through the light guide body.

12. The display apparatus according to claim 1, wherein the partitions are composed of burn-in spots that at least contact one another in a vertical direction.

13. The display apparatus according to claim 12, wherein the burn-in spots comprise agglomerates of carbon precipitates of the transparent plastic compound.

14. A method for manufacturing a display apparatus of a vehicle the display apparatus illuminated indirectly with a light guide body, the method comprise:
manufacturing a plate of a light guide material for a plurality of light guide bodies for display apparatuses;
introducing optically shielding partitions into the light guide bodies to form light guide zones;
dividing the plate of light guide material into individual light guide bodies that are adapted to a size and a shape of a display screen; and
assembling the display apparatus comprising display screen and background lighting with light guide zones of a light guide body optically shielded from one another by introduced optically shielding partitions through installation of the light guide body and illuminants for different-colored illumination of the light guide zones of the light guide body into a light box.

15. The method according to claim 14, wherein the introducing optically shielding partitions is executed by a three-dimensional laser scanner in such a manner that light spots are formed in a transparent plastic compound, which at least contact one another a vertical direction through the light guide body.
